(19) United States
(12) Patent Application Publication
(10) Pub. No.: US 2008/0295464 A1
(43) Pub. Date: Dec. 4, 2008

(54) HEAD GEAR FOR A HORSE

(76) Inventor: Danielle Larose, Lachine (CA)

Correspondence Address: BERESKIN AND PARR, 40 KING STREET WEST, BOX 401, TORONTO, ON, M5H 3Y2, CA

(21) Appl. No.: 11/755,031

(22) Filed: May 30, 2007

(51) Int. Cl. B68B 1/02

(52) U.S. Cl. 54/24

(57) ABSTRACT

The present invention discloses a head gear for a horse. The head gear comprises a cap, two earpieces, a nosepiece and an attachment. The cap is shaped to conform to a top portion of a horse's head. Both earpieces are attached to the cap and are adapted to cover both horse's ears. The nosepiece is connected to the cap and extends away from the cap solely between the horse's eyes and partially over the horse's nose. The attachment is used to fix the lower extremity of the nosepiece so that in use the nosepiece stays in proximate relationship with the horse's nose, thereby preventing it from moving when the horse is in motion. The head gear is made of fabric and the nosepiece is adapted to carry an image such as a sponsor's name, logo, publicity or other design.

### FIELD OF THE INVENTION

The present invention generally relates to the field of head gears for horses. More specifically, the invention relates to a head gear for a horse having available space suited to bear an image, a sponsor's name, logo, publicity and/or design.

### BACKGROUND OF THE INVENTION

Since the dawn of times, horses and men have had a special relationship. Men have used horses for work or recreation and in return have taken good care of them. In so doing, men have devised different ways of improving the comfort and efficiency of their horses. For example, different types of head gear for horses, having different functions, have been used.

The horse's head is a vulnerable target during bug season. Face flies seeking mucous-membrane moisture irritate the horse's eyes and can trigger allergies or infections. Voracious gnats creep into the horse's ears and leave crusty scabs and discomfort behind. A solution is to apply fly repellent to the horse. Such fly repellent however, although helping keep insects away from most of the horse's body, is a challenge to apply to its head and ears for full protection.

Modern head gear for horses typically divides into two categories: fly masks and ear nets. Fly masks cover most of the horse's face, including the eyes. Some fly masks also include earpieces in order to keep flies off the horse's ears and is used mostly when the horse is in a field. The second type of head gear used is the ear net. As its name indicates, its function is to keep flies off and out of the horse's ears. This type of head gear is used in trail riding and competitions where flies can get into the horse's ears and distract it. In trail riding and competitions, the horse's eyes are not to be covered as the horse needs an unimpaired vision in order to perform.

While ear nets are quite small and light, and therefore well suited for competition use, a marketing opportunity is missed should one want to display an image such as a sponsor's name, logo, publicity and/or a design. Since most media pictures and videos are taken showing the horse head and its rider, it would be beneficial to increase the amount of advertising space on the horse's head. U.S. Pat. No. 4,040,239 to Powell provides an example of protective head gear for a horse. This protective gear has much space for displaying sponsors. However, this type of head gear is bulky and heavily made and while being well suited for protection, is not suited for competition. U.S. Pat. No. 6,128,891 to McMahon provides an example of a fly bonnet. Again, although the head gear provides much advertising space, it is not suited for competition since it covers the horse's eyes. Furthermore, the material used, which is some kind of stiff mesh material, is neither suited for use in competition or to carry an image such as a sponsor's logo.

Hence, a need exists for an improved horse's head gear suited for trail riding and competition and which provides added space for displaying an image such as the sponsor's name or logo, a design or publicity.

### SUMMARY OF THE INVENTION

It is an object of the present invention to provide a head gear for a horse that overcomes or mitigates one or more disadvantages of known horse's head gear, or at least provides a useful alternative.

The invention provides the advantages of providing added space for displaying an image such as a sponsor's name or logo, a design or publicity.

In accordance with an embodiment of the present invention, there is provided a head gear for a horse. The head gear comprises a cap, two earpieces, a nosepiece and an attachment. The cap is shaped to conform to a top portion of a horse's head. Both earpieces are attached to the cap and are adapted to cover both horse's ears. The nosepiece is connected to the cap and extends away from the cap solely between the horse's eyes and partially over the horse's nose. The attachment is used to fix the lower extremity of the nosepiece so that in use the nosepiece stays in proximate relationship with the horse's nose. The head gear is made of fabric.

### BRIEF DESCRIPTION OF DRAWINGS

These and other features of the present invention will become more apparent from the following description in which reference is made to the appended drawings wherein:

FIG. 1 is a plan view of a head gear for a horse in accordance with an embodiment of the present invention.

FIG. 2 is a perspective view of a horse wearing the head gear of FIG. 1.

FIG. 3 is a plan view of a head gear for a horse in accordance with another embodiment of the present invention.

FIG. 4 is a plan view of a head gear for a horse in accordance with yet another embodiment of the present invention.

### DETAILED DESCRIPTION OF THE INVENTION

The head gear of the present invention is adapted to be placed on a horse's head and nose. The head gear covers horse's ears so that flies cannot enter. The head gear further extends between horse's eyes and over its nose to provide added advertising space while not obstructing the animal's vision. The head gear may be made of a light fabric that allows the horse's skin to breathe underneath while providing an adequate medium for bearing a sponsor's image.

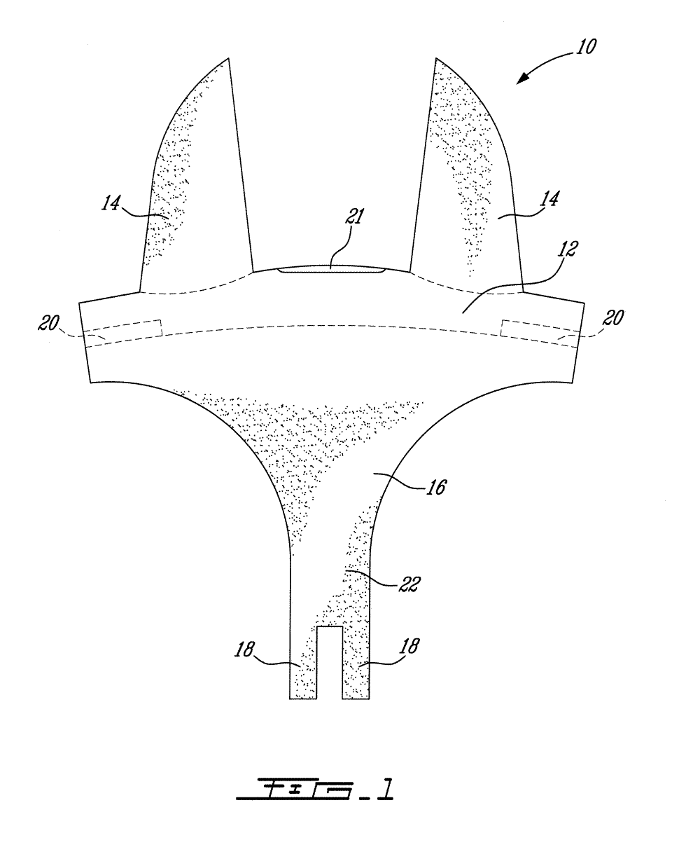

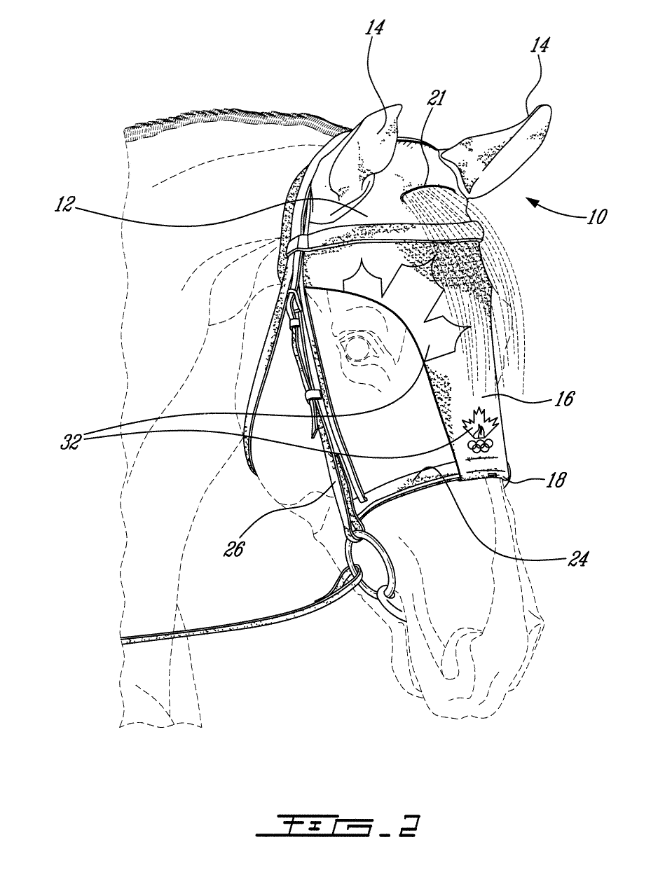

FIG. 1 depicts a head gear 10 for a horse according to an embodiment of the invention. The head gear 10 comprises a cap 12, two earpieces 14, a nosepiece 16 and attachment means 18. The cap 10 is shaped to conform to a top portion of the horse's head, as is best shown in FIG. 2 and which is concurrently referred to. Small elastic bands 20 may be added to help maintain the cap 12 of the horse's head.

Both earpieces 14 are attached to the cap 12. The earpieces 14 are adapted to cover the horse's ears to prevent flies from entering the ears and biting, thus distracting the horse.

Optionally, the cap 12 may be provided with an opening 21 between both earpieces 14. This opening 21 allows a horse's forelock to protrude through the head gear 10.

The nosepiece 16 is actually an extension of the cap 12 over the horse's nose. The nosepiece 16 may cover more or less of the horse's nose, but is typically designed to cover approximately half of the nose. The nosepiece 16 is shaped to extend between the horse's eyes so as to not obstruct the horse's vision, which is very important in trail riding and competition. A transition between the cap 10 and the nosepiece 16 may be done in many different ways and is more a question of aesthetic preferences. A smooth rounded transition is depicted here. The nosepiece 16 may extends solely between the horse's eyes or, alternatively, around the horse's eyes. The nosepiece 16 extends up to its lower extremity 22 where the attachment 18 is provided.

The attachment 18 is used to secure the nosepiece 16 over the horse's nose. Because the attachment 18 keeps the nosepiece 16 tightly in place close to the horse's nose when the horse is in motion, the nosepiece 16 may be used to display an image such as advertisement, publicity, a sponsor's logo or name, etc. The attachment 18 may be one or two attaching tabs adapted to surround a noseband 24 of a bridle 26 and attach to the nosepiece 16 so as to keep it in place. The attachment 18 may be provided with either press buttons (snaps), buttons, buckles, a hook and loop type of fastener (such as Velcro™) so that they can easily be attached and detached from the noseband 24.

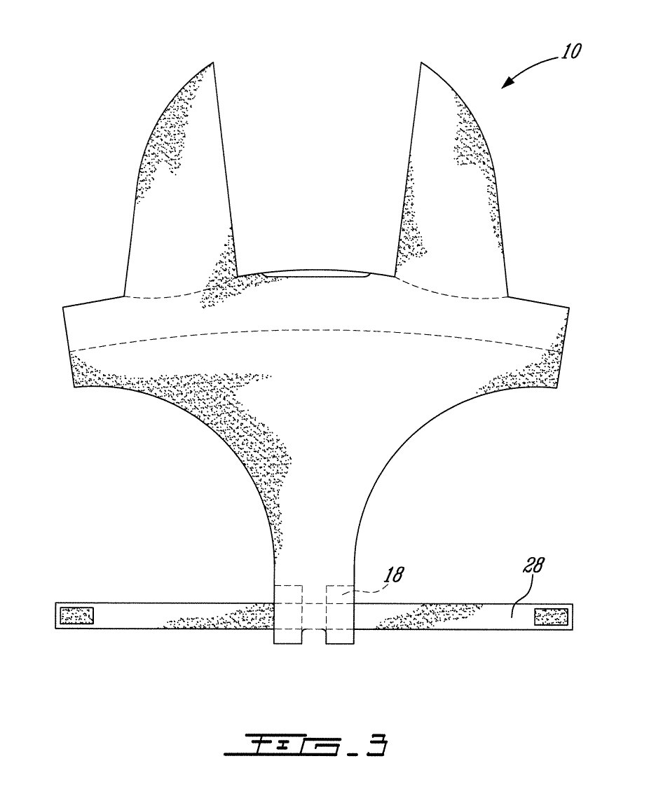

Some bridle models are not provided with the noseband 24 over the horse's nose. In this case, it may be necessary to provide the head gear 10 with its own noseband. This alternative embodiment is depicted in FIG. 3, which is now referred to. The attachment 18 is depicted having its own nose noseband 28. The noseband 28 may be provided with Velcro™, with a conventional buckle system, or any other adequate means.

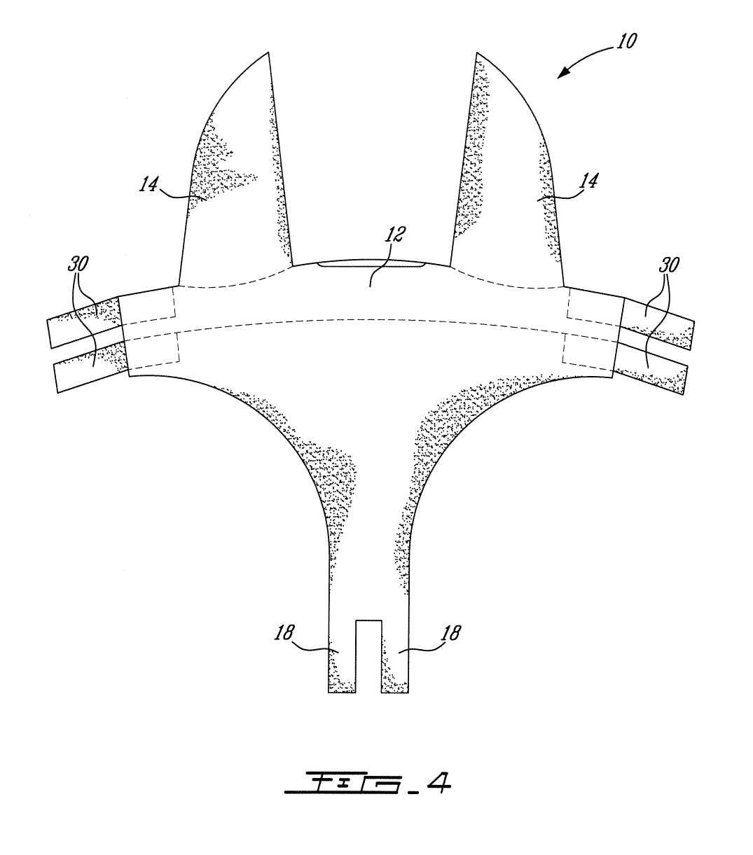

Turning now to FIG. 4, there is depicted another embodiment of the invention where the head gear 10 now comprises additional lateral attachments 30. The lateral attachments 30 are provided on the cap 12, close to each earpiece 14 and, similarly to the attachment 18, are adapted to attach over a strap of the bridle in order to secure the cap 12 over the horse's head. The lateral attachments 30 may be one or many tabs provided with Velcro™ or any other convenient fastening means.

In any of the embodiments of the present invention, it is preferable that the head gear 10 be made of a lightweight fabric that is comfortable for the horse. Furthermore, the fabric is preferably chosen for its capacity to carry an image. Different types of techniques may be used to fix an image on the fabric. For example, silk screening, embroidery or image transfer may be used. Although many fabrics may be used, it has been found that a fabric containing either polyester or polyamid fiber is preferred since this material is compatible with the sublimation image transfer process, which provides a very good image quality. The content of polyester or polyamid fiber is such fabric may be in the range of 75%. The sublimation image transfer process provides high resolution image transfer while retaining the fabric permeability. Hence, as shown in FIG. 2, which is now referred to, an image 32 may be opposed to the head gear 10. Positioning the image 32 on the nosepiece 16 provides the advantage of being highly visible when action pictures of the horse and rider are taken. Optionally, the image 32 may also extend to the cap 12.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

I claim:

1. A head gear for a horse having a head, ears, eyes and a nose, the head gear comprising:
a cap shaped to conform to a top portion of the horse's head;
two earpieces attached to said cap, said earpieces being adapted to cover both horse's ears;
a nosepiece connected to said cap, said nosepiece extending away from said cap solely between the horse's eyes and partially over the horse's nose; and
an attachment for fixing said lower extremity so that in use said nosepiece stays in proximate relationship with the horse's nose wherein said head gear is made of fabric.

2. The head gear of claim 1 wherein said attachment is a noseband adapted to surround the horse's nose and attach to itself.

3. The head gear of claim 1 wherein said attachment is a noseband adapted to surround the horse's nose and attach to a lower extremity of said nosepiece.

4. The head gear of claim 1 wherein said attachment is a first attaching tab adapted to surround a noseband of a bridle and attach to said nosepiece.

5. The head gear of claim 4 further comprising two second attaching tabs, each second attaching tab being located on said cap proximate a different one of said earpiece, each of said second attaching tab being adapted to surround a strap of the bridle and attach to said cap.

6. The head gear of claim 5 wherein said first tab and said second tabs each uses pieces of a hook and loop type of fastener.

7. The head gear of claim 5 wherein said first tab and said second tabs each uses a buckle.

8. The head gear of claim 5 wherein said first tab and said second tabs each uses buttons.

9. The head gear of claim 4 wherein said cap further comprises an opening between said earpieces to allow a forelock of the horse to protrude through said opening.

10. The head gear of claim 4 wherein said fabric contains a fiber selected from the group consisting of polyester and polyamid.

11. The head gear of claim 10 wherein said fabric contains approximately 75% of polyester fiber.

12. The head gear of claim 10 wherein said fabric contains approximately 75% of polyamid fiber.

13. The head gear of claim 10 further comprising an image on said nosepiece.

14. The head gear of claim 13 further comprising an image on said cap.

15. The head gear of claim 14 wherein said image is made by sublimation.

16. The head gear of claim 14 wherein said image is made by silk screening.

17. The head gear of claim 14 wherein said image is made embroidery.
